(19) United States
(12) Patent Application Publication
(10) Pub. No.: US 2010/0280873 A1
(43) Pub. Date: Nov. 4, 2010

(54) Electronic coupon storage and manipulation system and method

(76) Inventor: Justin K. Bryant, Stockbridge, GA (US)

Correspondence Address: George R. Schultz;Schultz & Associates, P.C., One Lincoln Center, 5400 LBJ Freeway, Suite 1200, Dallas, TX, 75240, US

(21) Appl. No.: 12/387,263

(22) Filed: Apr. 30, 2009

(51) Int. Cl. G06Q 30/00; G06F 17/00; G06F 17/30; G06Q 10/00

(52) U.S. Cl. 705/10; 235/375; 707/E17.017; 707/E17.044; 705/14.39; 705/14.33

(57) ABSTRACT

A system and method for scanning paper coupons and coordinating their use with electronic coupons for the provided is a internet based electronic coupon searching system. Further provided, is a method and apparatus to combine electronic and paper coupons into a master coupon for secure redemption through an electronic coupon clearing house and offering coupon distribution system.

### FIELD OF THE INVENTION

The present invention relates to the field of coupon scanning devices and coupon redemption systems. A marketing coupon is a ticket or document that can be exchanged for a financial discount or rebate when purchasing a product. Typically, coupons are issued by manufacturers of package consumer goods to be used in retail stores as part of sales promotions. Coupons are widely distributed through mail, magazine, newspapers and the internet and more recently on mobile devices such as cell phones.

Coupons first saw widespread use in the United States in the 1900's to sell carbonated beverages and other products.

More recently, online retailers had developed “coupon codes” or “promotional codes” as an alternative to coupons. Printable coupons from the internet have also recently become popular. However, printable coupon fraud is rampant because the technology behind the concept was not sufficient to overcome technology minded counterfeiters. Also, while internet coupons typically provide reduced costs for various products, they do not coordinate well with more traditional paper coupons.

### BACKGROUND OF THE INVENTION

U.S. Patent Application 2004/0112958 discloses a Coupon Scanner Organizer Device. The Device consists of a PDA with barcode reader. The consumer may scan bar codes for coupons and store the relevant information. Software on the PDA allows the consumer to organize the coupons by brand, product or amount. The PDA may redeem coupons by connecting to the cash register through a wireless or wired connection. Alternatively, the PDA may print the appropriate coupon. Additionally, product UPCs may be scanned to determine if they match coupons stored in the PDA. Finally, the PDA may read a consumer's store discount card information and pass that information to the register at checkout time.

U.S. Patent Application 2003/0024981 discloses an Automated Coupon Solution. A PDA is employed to scan consumer products. The PDA connects to the internet and searches for coupons or rebates matching the scanned item. The coupons are downloaded into the PDA. The coupons may be sent directly to the manufacturer, downloaded through wireless or wired connection to the stores computer or printed from the PDA. Information may be stored to fill in rebate forms to send directly to manufacturers or printed and mailed. Information from store preferred shopper cards may also be stored and sent to the store computer.

U.S. Pat. No. 5,192,854 to Counts discloses a Hand Held Coupon Scanner at a retail store. The Scanner stores information relevant to the coupon such as product, amount and expiration date. At checkout, the UPC of purchased products are scanned. The coupon scanner is connected to an Input/Output port of a store coupon recorder. The recorder compares the UPC of the products with the coupons to determine matches. Additionally, the recorder compares the coupons to a database to determine if they are authentic. If a coupon matches a product and is authentic, the customer receives the coupon amount.

U.S. Pat. No. 7,198,192 to Page et al. discloses a PDA with a Barcode Reader. A consumer scans in a UPC from a product. Software in the PDA determines the type of product, size, color, etc. The PDA connects to a website that has reviews of that product and similar products. Additionally, the website may contain information about cost, rebates and incentives offered by manufacturers.

U.S. Patent Application 2007/028831 to Brodson et al. discloses an E-Coupon System and method. A consumer searches a website for coupons via a PDA. The coupons may be downloaded and sorted by brand, product and store. Alerts may notify the consumer of new or expiring coupons. A database may be created with consumer account information and the coupons downloaded by the consumer.

U.S. Patent Application 2005/0010476 to Combs discloses a consumer specific marketing tool method and apparatus. Information on a customer is gathered at a point of sale or through a preferred shopper's card. Information may include items purchased, age, gender and existing health issues. Information regarding the consumer's specific demographic is produced along with coupons that reflect the consumer's preferences. i.e. a vegetarian may receive information about additional protein requirements and coupons that do not relate to meat items. The information and coupons may be sent to a PDA. The coupons may be printed from the PDA or the bar code scanned directly from the PDA's display. The store may track a customer's use of coupons.

UK Patent Application GB 2,392,286 to Wu discloses a Method to Scan Bar Code from the screen of a PDA. The Bar Code may be scanned into the PDA. Alternatively, a picture of the bar code is taken by the PDA. Software then determines the proper bar code for the item and displays it on the PDA screen.

Therefore, a need exists for a PDA that will store data from paper coupons as well as search for electronic coupons based on information scanned from a product's UPC or RFID code. Further, there is a need for a product that will exchange information between a consumer and a manufacturer to allow offers or coupons to be tailored to an individual consumer based on the consumer's purchases of competing products or loyalty to a manufacturer. Also, a need exists for a secure method and system for securely transferring paper coupons to any electronic form to prevent fraud.

### SUMMARY OF INVENTION

The invention relates to a PDA that uses a barcode scanner to scan physical coupons. The PDA may note the expiration date of the coupon and notify the consumer. Additionally, websites may be searched for coupons that are then downloaded to the PDA. A computer PDA based web-browser may be used to perform the search. Websites are searched for electronic coupons corresponding to Uniform Product Code (UPC) of items that the consumer has scanned.

One embodiment of the invention accelerates repayment of redeemed coupon value to the retail store. The PDA encodes the coupon data to create a single master bar code that is transmitted to the store computer. The store computer decodes the master bar code and provides the discounts appropriate to the individual coupons. The store then submits the master bar code to a coupon clearinghouse server. The server decodes the coupons, checks the validity of the coupons against a data base of valid coupons and notifies the appropriate manufacturer of the redemption of the coupon. The manufacturers pay the appropriate amount to the store based on the value of the coupon. The manufacture benefits from a reduced cost due to using an automated clearinghouse to redeem coupons and the store benefits from a quicker reimbursement of coupon payments made to customers.

The device comprises a hand held PDA unit with a bar code scanner and an on-board printer capable of generating readable bar codes. The bar code scanner is in communication with the PDA. Information from physical coupons is read by the scanner and stored in the PDA. Software stored in the microprocessor of the PDA reads bar codes from physical coupons and identifies the product for which the coupon is generated, the value of the coupon, the date of expiration of the coupon and any other important information. The software on the PDA organizes and searches the coupon data. Additionally, the PDA communicates through a USB port or similar connection to a desktop computer which organizes coupon information and displays it in various reporting formats.

A website interface is provided which accesses one or more databases containing electronic coupon information. The databases can be searched for categories such as product name, category, or company name. The website may be reached through the PDA itself or through a desktop computer and downloaded into the PDA through a USB or similar connection. The electronic coupon information may be sorted by the PDA or desktop computer, along with information stored from physical coupons.

The PDA or desktop computer passes information about the consumer to various manufacturers. The information includes demographics such as the age, sex and location. Additionally, manufacturers receive information about coupons that have been redeemed or downloaded and not redeemed. This information is used by the manufacturers to customize coupons for that individual. As an example, a competing manufacturer may wish to offer a much larger discount coupon to someone that has purchased a competing product. Manufacturers may also use this information to reward loyal customers either through additional coupons or a reward/point system.

Software in the PDA and computer allows the consumer to search through the coupons that have been used or downloaded. The consumer may examine the amount saved on coupons used, expiration date of coupons, date used, or by product. Additionally, the PDA will notify the consumer prior to the expiration of a coupon that has been downloaded.

A wireless connection on the PDA allows searches for coupons while shopping. A consumer may scan a product's UPC while shopping. Software in the PDA will identify the manufacturer and type of product. The consumer may then access a website and search for electronic coupons for that product or similar products from competitors. Electronic coupons may be downloaded directly to the PDA enabling a customer discount.

The PDA speeds coupon redemption by encoding all of the coupons to be redeemed into a secure and unique master bar code. Physical and electronic coupons may be redeemed using the master bar code at a store location by printing the master barcode, reading the master barcode from the PDA's screen, sending the master barcode data directly to the manufacturer or downloading directly into a store computer or sales register. The master barcode is printed and scanned into a store computer as a normal coupon. Similarly, the master barcode may be read directly from the PDA screen by the appropriate scanning device at the store. The master barcode data may be sent directly to a manufacturer that has an appropriate website or other access. The PDA may access the manufacturer by phone, WIFI or other similar means. Finally, the master barcode data may be downloaded directly into a store computer or registered using a wireless connection such as infrared or a wired connection such as a USB port. The store computer decodes the master barcode into the individual coupons, matches coupons to purchased products and reduces the customer's total by the appropriate amount. The store sends the master barcode data to a clearinghouse server through the internet. The clearinghouse server then decodes the data into individual coupons. The coupons are then verified against a database of valid coupon offers. If the coupons match a valid coupon offer, the appropriate company is notified of the redemption of the coupon and its amount. The use of a secure electronic coupon clearinghouse saves the manufacturer the handling charge that is generally associated with redeeming coupons. Additionally, the store benefits from quicker reimbursement of coupon payments made to customers.

Similarly, the PDA is used to store manufacturer's rebate forms. The PDA or desktop computer stores consumer information such as name, address and phone number. This allows the PDA to fill out a rebate form automatically. The rebate form is sent directly to the manufacturer via a cell phone or WIFI connection. If a manufacturer does not have the appropriate connection, the rebate form may be printed and sent via paper mail. The PDA will automatically remind the consumer that a rebate should be received at an appropriate time, generally six to eight weeks.

Embodiments of the invention offer an improvement of scanning existing physical coupons and searching for additional electronic coupons via the internet. Embodiments of the invention allow sorting both types of coupons by category; including product, expiration date and amount saved. The invention allows an interactive website where a consumer's demographics, purchases and downloaded coupons are visible to manufacturers. Manufacturers may use this information to send coupons to a consumer who uses a competitor's product or to a loyal consumer. The master barcode generated by the PDA is an improvement in that multiple coupons can be redeemed at one time, both by the consumer and by the store. Additionally, the master barcode data is in electronic form. This allows the coupons to be redeemed by a secure electronic coupon clearinghouse rather than be mailed and sorted by hand as is done with paper coupons. The result is a savings in time to the customer, coupon redemption costs to manufacturers and quicker repayment of redeemed coupons to the store.

Those skilled in the art will appreciate the above-mentioned features and advantages of the invention together with other important aspects thereof upon reading the detailed description that follows in conjunction with the drawings provided.

### BRIEF DESCRIPTION OF THE DRAWINGS

In the detailed description of the preferred embodiments presented below, reference is made to the accompanying drawings.

FIG. 1 is an isometric view of a preferred embodiment with a built in scanner.

FIG. 2 is an isometric view of an alternate embodiment with a scanner attached by cable.

FIG. 3 is a schematic drawing of the system architecture used to input coupon data into the PDA.

FIG. 4 is a schematic drawing of the system architecture used to export coupon data to the store and manufacturer from the PDA.

FIG. 5 is a flowchart showing the preferred method of comparison between coupon data and data from purchased products.

FIG. 6 shows a block diagram of the preferred components that comprise the scanning unit.

FIG. 7 is a flowchart showing a preferred method performed when the invention is used with paper coupons.

FIG. 8 is a flowchart showing a preferred method performed when the invention is used with paperless or electronic coupons.

FIG. 9 is a flowchart showing a preferred method performed when the invention is used to redeem manufacturer's rebates.

FIG. 10 is a flowchart showing a preferred method performed when a manufacturer customizes offers to a specific consumer based purchase history.

FIG. 11 is a block diagram showing the functional sections of a coupon search application that resides a server.

### DETAILED DESCRIPTION OF THE PREFERRED EMBODIMENT

In the descriptions that follow, like parts are marked throughout the specification and drawings with the same numerals, respectively. The drawing figures are not necessarily drawn to scale and certain figures may be shown in exaggerated or generalized form in the interest of clarity and conciseness.

Personal digital assistant (PDA) 102 may be a cell phone, hand-held computer or similar device. In preferred embodiments, the PDA may be a Black Berry 3220® or an Apple iPhone®. Other similar devices may be used in the spirit of the invention.

The PDA 102 contains a software application that allows it to communicate with memory and communication ports that reside on the PDA 102. The software contains proper communication protocols such as tcp/ip, ftp, http, ftp, smtp and snmp as are well known in the industry. The communication protocols allow PDA 102 to communicate with external devices and networks.

The software application that allows the PDA 102 to perform the storage, sorting and communication of the invention may be written in C++, Java, or a similar computer language. It is envisioned that the software application may be installed on the PDA 102 at the time of purchase, loaded to the PDA through a communication port or down loaded as an application from a website, such as the App Store from Apple®.

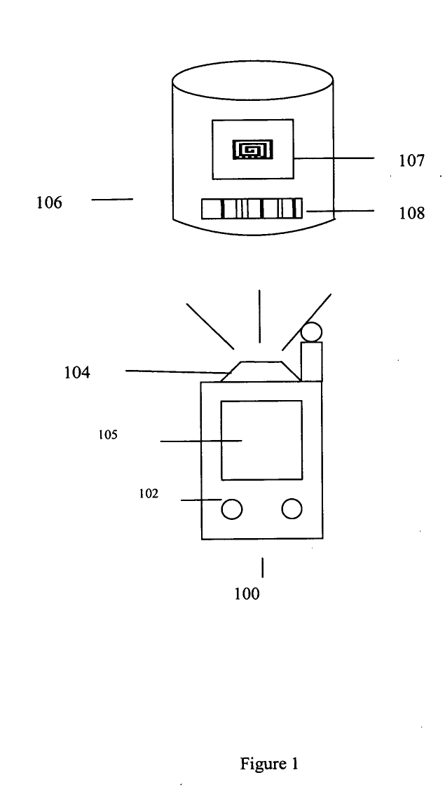

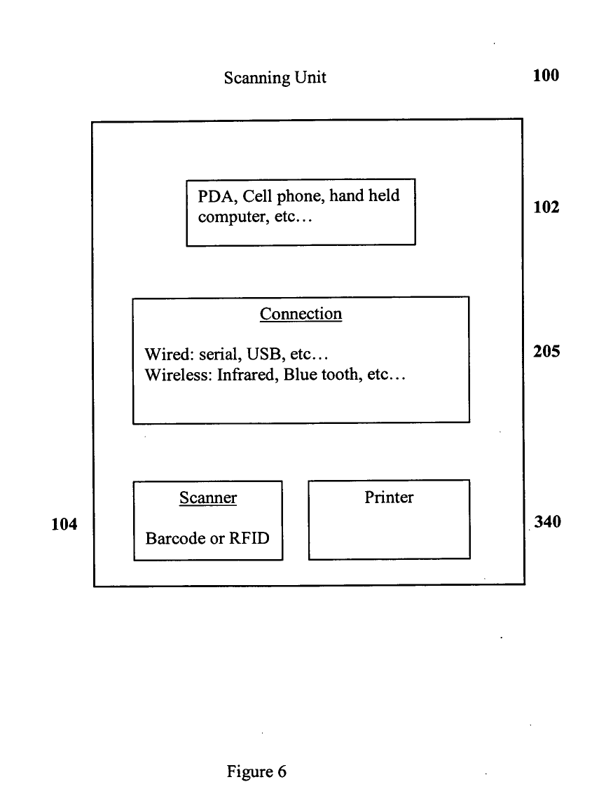

The coupon scanning device is shown in reference to FIGS. 1 and 6. Coupon scanning device 100 consists of a PDA 102 and scanner 104. A device screen 105 is incorporated into PDA 102. PDA 102 is connected to a scanner 104. Printer 340 may be integral with scanning device 100 or otherwise connected with a wired 205 or wireless connection.

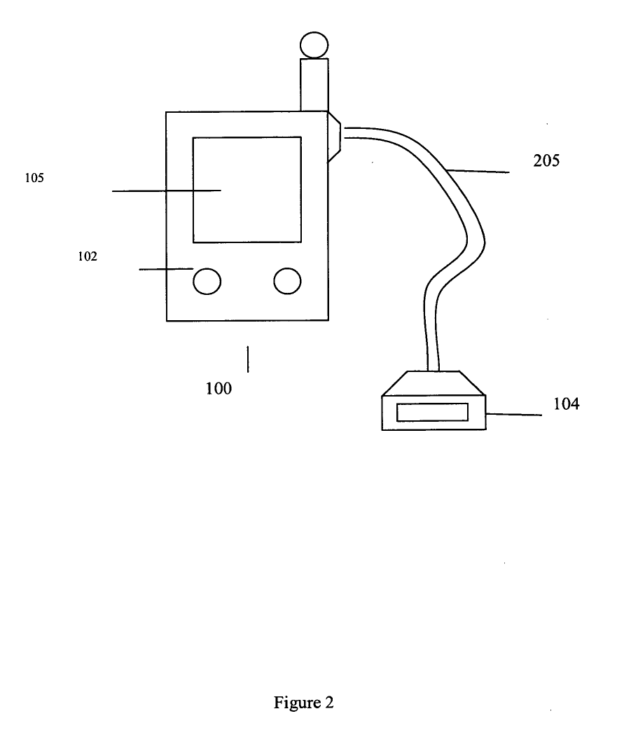

Referring now to FIGS. 1, 2 and 6, Scanner 104 may also be integrated into PDA 102. Scanner 104 may also connect to PDA 102 via a CF expansion slot designed to enable peripheral attachments, such as the 221002 RFID reader from GAO RFID Inc. Scanner 104 may be connected via a serial, USB, or similar cable 205. The IDTech EconoScan IDT4431-4UB is an example of a barcode scanner that attaches via a USB cable. Scanner 104 may also be connected wirelessly via cell phone, Bluetooth, WiFi, or other wireless connections as are well known in the art.

FIG. 1 shows a preferred embodiment of the scanning device 100 as the scanner 104 gathers data from item 106. Scanner 104 gathers information about item 106. Item 106 may be a physical package or a physical coupon. The physical package or physical coupon may provide data related to item 106 by a Radio Frequency Identification (RFID) 107 tag or a UPC barcode 108. Scanner 104 converts the information of the barcode or RFID tag into digital data and communicates the data to PDA 102 where it is stored in memory.

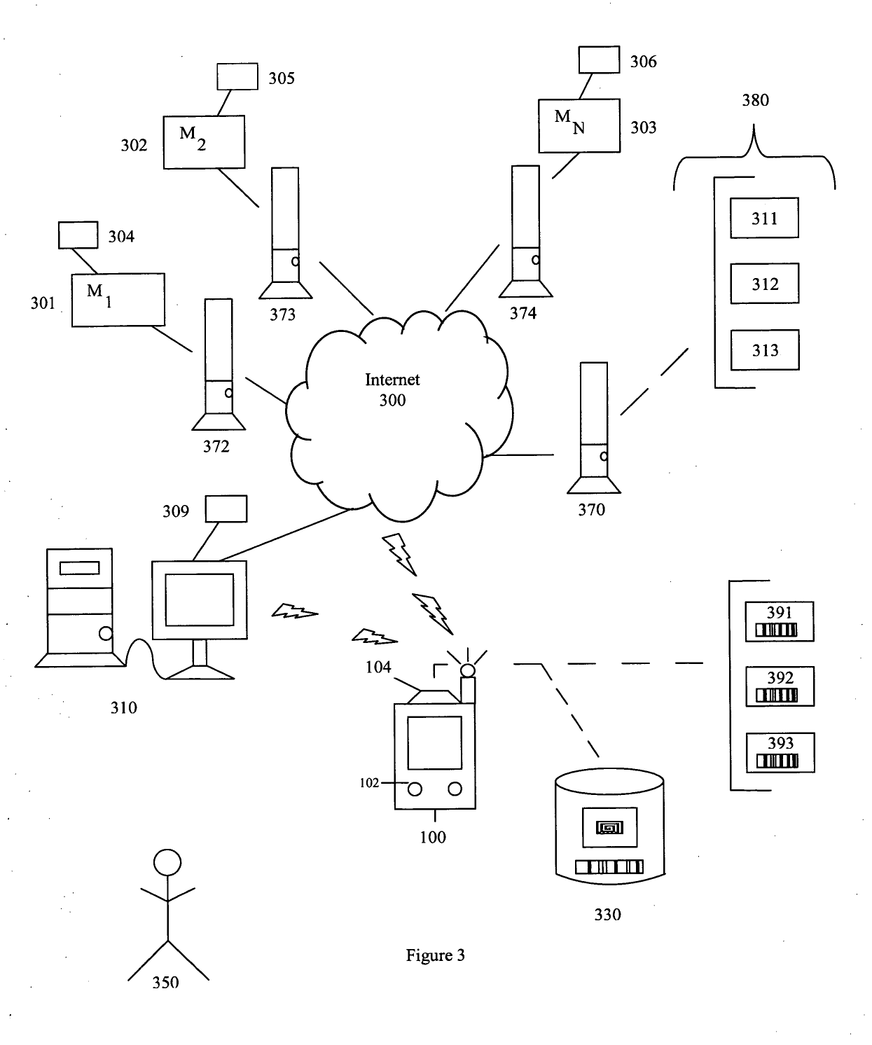

FIG. 3 illustrates system architecture relating to inputting coupon data into the PDA. Scanning device 100 communicates with personal computer 310 and internet 300. The connection may wired or wireless as known in the art.

Server 370 is connected to internet 300. A coupon webpage resides on server 370. The server has a coupon database 380 including coupon images and data 311, 312 and 313. The coupon webpage accesses the images and data. The webpage also searches internet 300 for additional coupon data. Coupon database 380 also stores customer demographic and product purchase information.

Coupon images and data 311-313 include additional data regarding manufacturer's rebates, electronic offers residing on internet 300, electronic offers sent directly to scanning device 100, paper coupons, or other offers where information is passed by barcode or RFID tag. Coupon images and data 311-313 are redeemable directly from the manufacturers 301-303 via the internet 300, at the point of sale, or via mail. Coupon images and data 311-313 may be redeemable for cash, goods or other benefits by consumer 350.

Database 309 resides on personal computer 310. An example of a personal computer is a Dell Latitude D800 with a Windows 2000 operating system, but other computers may be used. Database 309 stores coupon data. Personal computer 310 accesses the coupon webpage residing on server 370. Coupon images and data 311-313 are downloaded to database 309 via internet 300. Coupon images and data 311-313 are then loaded from personal computer 310 into scanning device 100.

PDA 102 of scanning device 100 may also be used to access the coupon website residing on server 370. Coupon images and data 311-313 are loaded directly to scanning device 100 via internet 330.

Manufacturers 301-303 are connected to internet 300 via servers 372-374. Databases 304-306 are connected to manufacturers 301-303. Databases 304-306 store customer information and coupon offers.

Manufactured product 330 represents an item that is scanned by consumer 350 while shopping. Manufactured product 330 passes information to scanning device 100 through a barcode or RFID tag.

Paper coupons 391-393 represent paper coupons scanned by consumer 350. Coupon data from paper coupons 391-393 enters scanning device 100 through scanner 104.

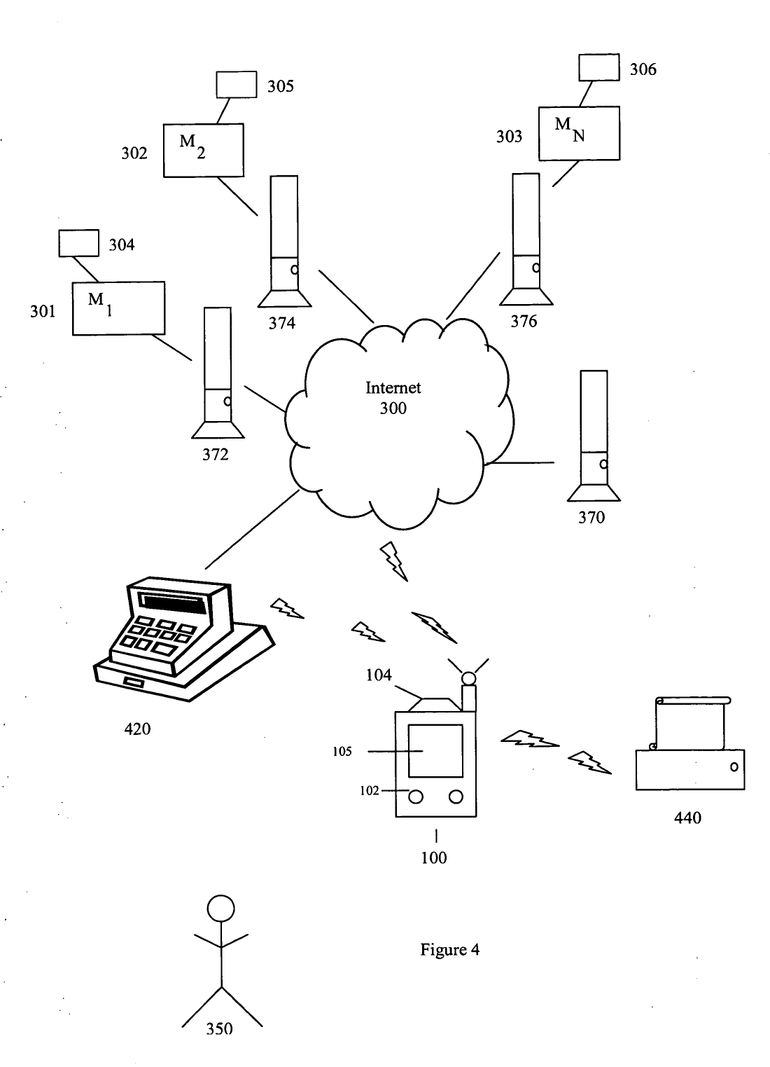

FIG. 4 illustrates system architecture relating to exporting coupon data from the PDA to redeem coupons. Coupon data is stored in scanning device 100. The data may be from scanned paper coupons or coupon images sent electronically. Store computer 420 is the electronic system a store uses to scan products and coupons. Scanning device 100 communicates with store computer 420, printer 440 and internet 300. The connection may wired or wireless as known in the art.

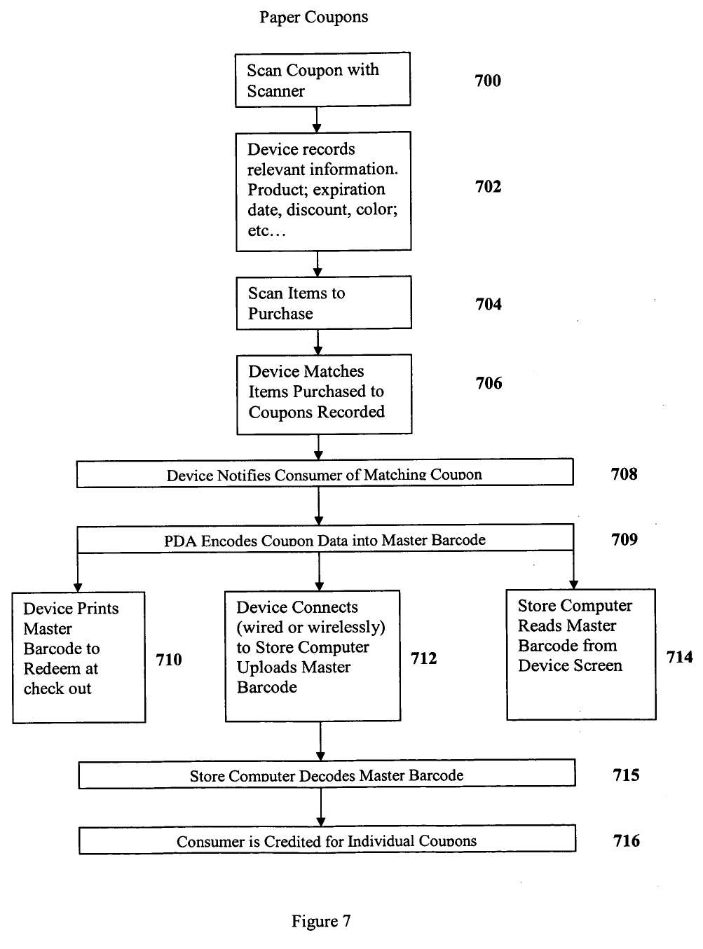

FIG. 7 shows a flowchart of the device in operation with paper coupons. FIG. 7 is discussed with reference to elements of FIGS. 3 and 4. At step 700, consumer 350 scans data from paper coupons 391-393 into scanning device 100.

At step 702, scanning device 100 records data from paper coupons 391-393. The data may include amount of discount, expiration date, manufacture, and product type.

At step 704, scanning device 100 records data from manufactured product 330 as purchased product data is scanned in by consumer 350.

At step 706, PDA 102 of scanning device 100 matches stored coupon data to purchased product data, such as manufactured product 330.

At step 708, scanning device 100 notifies consumer 350 of any matches between coupon data and purchased product data.

At step 709, consumer 350 signals scanning device 100 that all items have been purchased. PDA 102 of scanning device 100 uses data from stored coupons to create a single master barcode that identifies all of the coupon data that matches purchased product data.

Consumer 350 may redeem coupons that match purchased products in three separate ways: print a copy of the master barcode, scan master barcode data directly from device screen 105, and upload master barcode data directly to store computer 420.

The master barcode is printed using scanning device 100 attached to printer 440, as shown in step 710.

At step 714, coupons are redeemed by scanning the master barcode directly from device screen 105 of scanning device 100 into store computer 420. Scanning device 100 displays the barcode on the device screen 105 of scanning device 100. It is known in the art that CCD (charge coupled device) barcode scanners may read barcode images from computer screens. Thus, if a CCD barcode scanner is attached to store computer 420, consumer 350 may redeem coupons by scanning the master barcode data directly from device screen 105 of scanning device 100 into store computer 420.

At step 712, scanning device 100 may redeem coupons by uploading the master barcode data directly to store computer 420. Scanning device 100 may communicate with store computer 420 wirelessly via WiFi, Bluetooth, or similar wireless connection. Scanning device 100 may communicate with store computer 420 using cables such as serial, USB or similar cables. Once scanning device 100 is communicatively connected with store computer 420, scanning device 100 uploads coupon data to store computer 420.

At step 715, store computer 420 decodes the master barcode into individual coupons. Store computer then matches the individual coupons to manufactured product 330 ensuring that the consumer 350 is entitled to a rebate.

At step 716, consumer 350 is credited with the appropriate benefit based on the coupons downloaded that match products purchased by consumer.

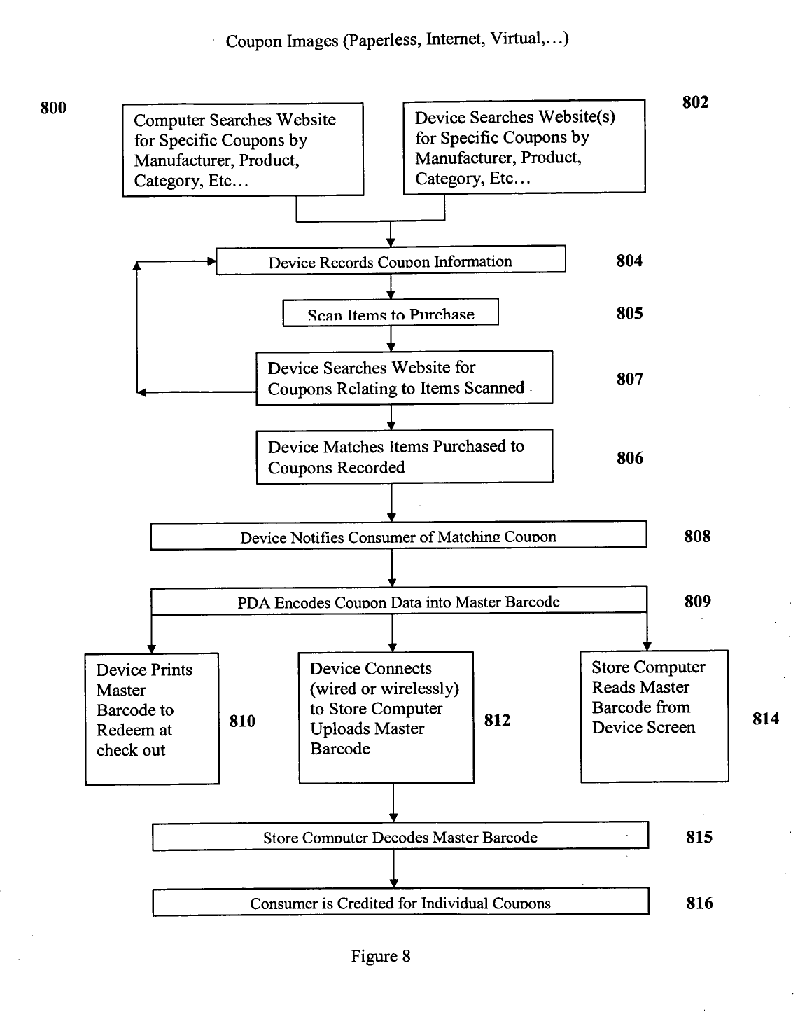

Referencing element numbers from FIGS. 3 and 4, FIG. 8 shows how consumer 350 uses personal computer 310 or scanning device 100 to download coupon images and data 311-313 (paperless, e-coupons, virtual coupons) from internet 300.

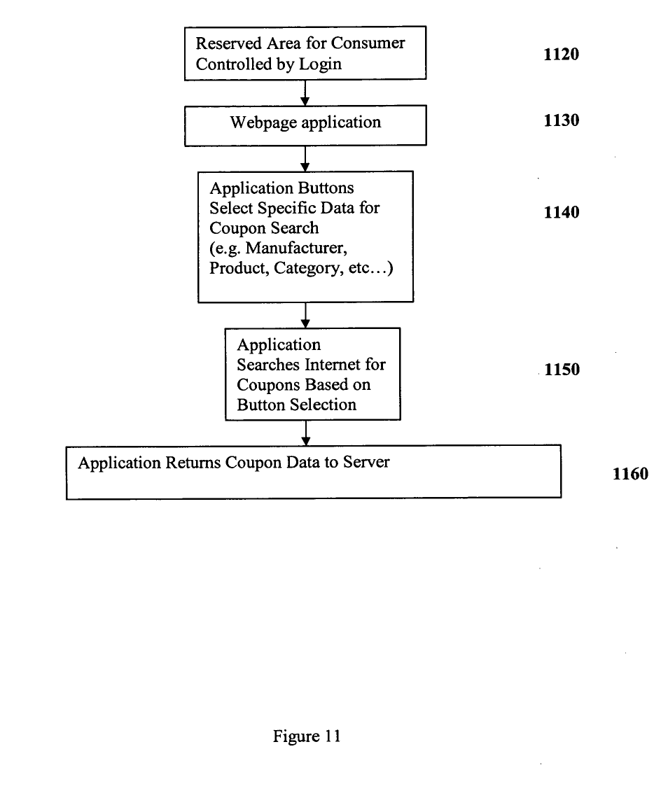

At step 800, consumer 350 uses personal computer 310 to search the server 370 for coupons via internet 300. An application that enables coupon searches resides on server 370. The application searches coupon database 380 and internet 300 to find coupon images and data 311-313. Coupon images and data 311-313 are downloaded via the internet 300 to computer 310. The operation of the application is described later in reference to FIG. 11.

At step 802, consumer 350 uses scanning device 100 to search the server 370 for coupons via internet 300. An application that enables coupon searches resides on server 370. The application searches a database of coupons and internet 300 to find coupon images and data 311-313. The operation of the application is described later in reference to FIG. 11.

At step 804, data, related to items scanned in step 805, from coupons images and data 311-313 is loaded into scanning device 100. Coupon images and data 311-313 are downloaded directly to PDA 102 of scanning device 100 from the server 370 via Internet 300 as discussed in step 802. Coupon images and data 311-313 are downloaded from personal computer 310 to PDA 102 of scanning device 100 as discussed in step 800.

At step 805, consumer 350 scans manufactured item 330 which consumer intends to purchase or wishes to determine if a coupon is available. Consumer 350 inputs purchased item data into scanning device 100 as described in FIG. 3.

At step 807, with reference to FIGS. 3 and 4, scanning device 100 initiates a search for coupons based on purchased product data, such as data from manufactured product 330. The application that performs the coupon search is discussed further in FIG. 11. PDA 102 of scanning device 100 connects to internet 300 and server 370. Scanning device 100 downloads the barcode or RFID data from manufactured product 330 to a coupon webpage residing on server 370. Coupon data is downloaded from server 370 to scanning device 100 at step 804. The series of steps 805, 807 and 804 may be repeated for each item purchased.

At step 806, scanning device 100 compares items the consumer has scanned to coupons recorded in its database.

At step 808, scanning device 100 notifies consumer 350 of any matches between coupon data and purchased product data.

At step 809, consumer 350 signals scanning device 100 that all items have been purchased. PDA 102 of scanning device 100 uses data from stored coupons to create a single master barcode that identifies all of the coupon data that matches purchased product data.

The single master bar code is created by a mathematical hash of the several bar codes in the various coupons. The hash is comprised of a mathematical addition of the numbers of the product bar codes plus a serialization for the master bar code which is unique to the master bar code. Other hash techniques may be used.

Consumer 350 may redeem coupons that match purchased products in three separate ways: print a copy of the master barcode, scan master barcode data directly from device screen 105, and upload master barcode data directly to store computer 420.

The master barcode is printed using scanning device 100 attached to printer 440, as shown in step 810.

At step 814, coupons are redeemed by scanning the master barcode directly from device screen 105 of scanning device 100 into store computer 420. Scanning device 100 displays the barcode on the device screen 105 of scanning device 100. It is known in the art that CCD (charge coupled device) barcode scanners may read barcode images from computer screens. Thus, if a CCD barcode scanner is attached to store computer 420, consumer 350 may redeem coupons by scanning the master barcode data directly from device screen 105 of scanning device 100 into store computer 420.

At step 812, scanning device 100 may redeem coupons by uploading the master barcode data directly to store computer 420. Scanning device 100 may communicate with store computer 420 wirelessly via WiFi, Bluetooth, or similar wireless connection. Scanning device 100 may communicate with store computer 420 using cables such as serial, USB or similar cables. Once scanning device 100 is communicatively connected with store computer 420, scanning device 100 uploads coupon data to store computer 420.

At step 815, store computer 420 decodes the master barcode into individual coupons. Store computer 420 then matches the individual coupons to manufactured product 330 ensuring that the consumer 350 is entitled to a rebate.

At step 816, Consumer 350 is credited with the appropriate benefit based on the coupons downloaded that match products purchased by consumer.

Referencing element numbers from FIGS. 3 and 4, FIG. 8 shows how consumer 350 uses personal computer 310 or scanning device 100 to download coupon images and data 311-313 from internet 300.

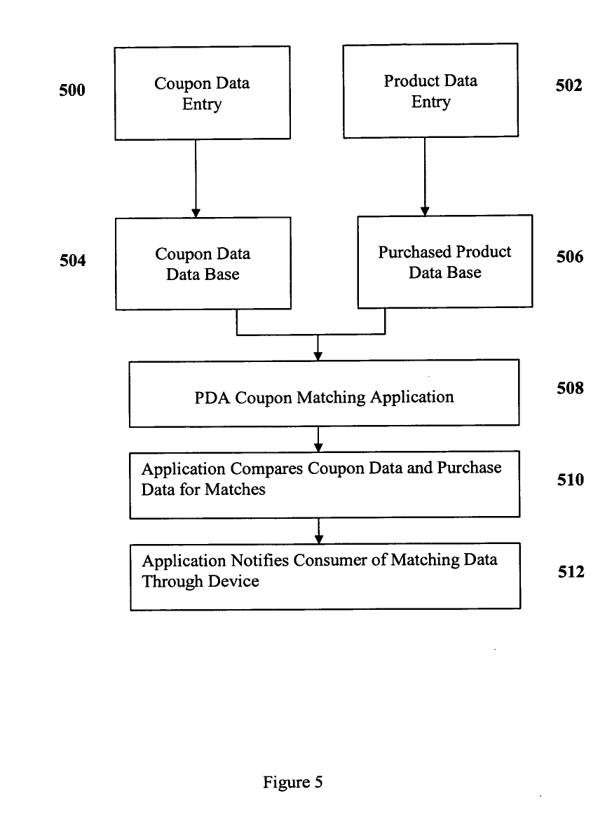

FIG. 5 shows the preferred method of comparing coupon data and purchased product data. At step 500, coupon data is entered from a paper or electronic offer or coupon. PDA 102 of scanning device 100 stores coupon data in a coupon data base at step 504. Purchased product data is entered by scanning products at step 502. PDA 102 of scanning device 100 stores product data in a purchased product data base at step 504. A matching application resides on PDA 102 of scanning device 100 at step 508. At step 510, the matching application compares data from the coupon data base and the purchased product data base 506. The consumer 350 is notified of matches between the data bases, representing redeemable coupons, at step 512.

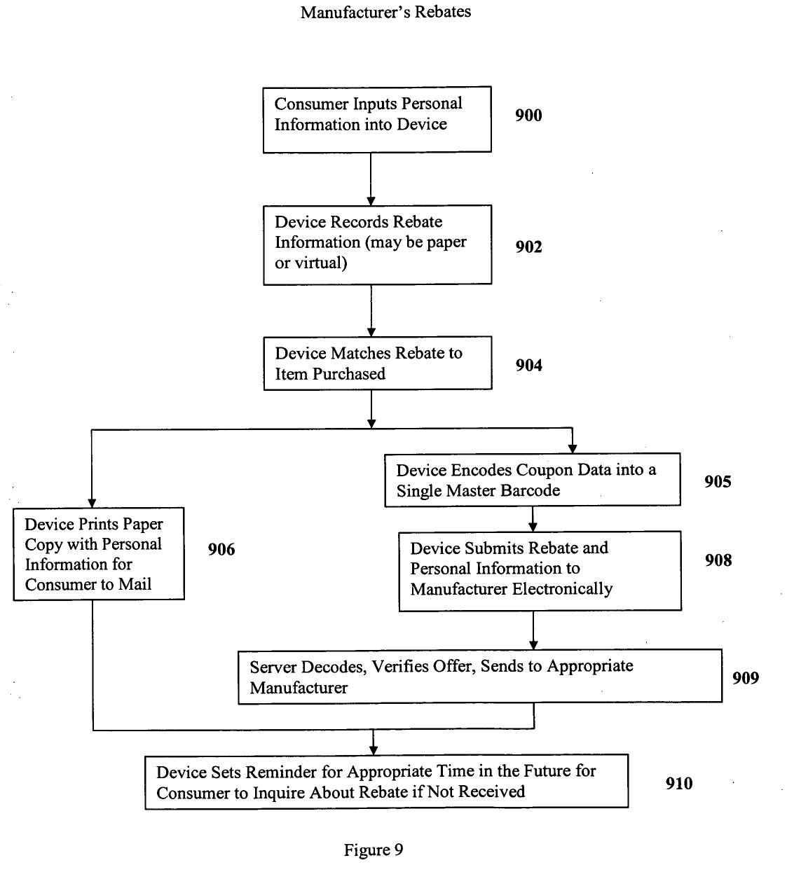

FIG. 9 shows how manufacturer's rebates or other offers that are not redeemable at the point of sale are redeemed using scanning device 100. Consumer 350 inputs personal information into PDA 102 of scanning device 100 at step 900. Personal information may be name, address, phone number, or other identifying information. Data from offers are entered into scanning device 100 at step 902. Offers may be paper or electronic and are stored in coupon database of scanning device 100. At step 904, the device determines that the requirements of the offers are met. This may include multiple purchases of a product over a period of time, purchase of several products simultaneously or a single purchase. Personal information that has been entered into scanning device 100 is integrated into the offers to be submitted. At step 905, PDA 102 of scanning device creates a master barcode of all offers to be redeemed and consumer's 350 personal information.

At step 908, scanning device 100 connects to internet 300 to submit the offer details and consumer information to server 370.

At step 909, server 370 decodes the master barcode data and verifies the offers against the valid coupon database. If an offer is valid, server 370 contacts the appropriate manufacturer 301-303. The manufacturer 301-303 receives notice of the redeemed offer and the consumer's 350 personal information.

At step 906, scanning device 100 is used to print offers from printer 440. Offers that include data to allow PDA 102 to determine the correct location for consumer's 350 personal information are filled out automatically using consumer's 350 personal information that is stored in scanning device 102. Offers that do not allow the PDA 102 to identify the proper place to print consumer's 350 personal information are printed and filled out by consumer 350. Consumer 350 then mails the completed offer to the appropriate manufacturer.

At step 910, the scanning device 100 sets a reminder to notify consumer 350 to inquire about the offer if a rebate has not been received, generally six to eight weeks.

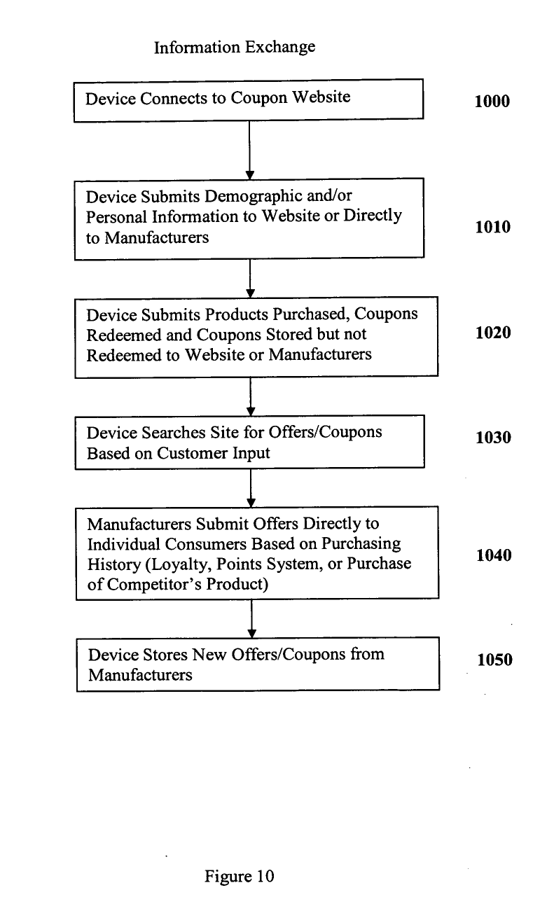

FIG. 10, with reference to FIGS. 3 and 11, shows how consumer 350 and manufacturers 301-303 exchange information over the server 370. Consumer 350 enters demographic information such as age, sex, zip code, etc. into scanning device 100 or directly into a coupon webpage residing on server 370 via scanning device 100 or personal computer 310. At step 1000, scanning device 100 connects to the coupon webpage residing on server 370 via internet 300. At step 1010, consumer demographic information is updated based on information residing on scanning device 100. At step 1020, coupon information is updated. Coupon information includes products that have been scanned, coupons that currently reside on scanning device 100 or coupons that have been redeemed by scanning device 100. Scanning device 100 sends the information of steps 1010 and 1020 to be loaded onto coupon webpage residing on server 370 or sent directly to manufacturers 301-303 via servers 372-374 connected to internet 300. At step 1030, scanning device 100 searches for additional coupons. At step 1040, manufacturers 301-303 make offers based on purchasing history of consumer 350. These offers may be based on loyalty to the manufacturer, a frequent purchaser point system, or the purchase of a competing product. The offers may be sent from servers 372-374 to the coupon webpage residing on server 370 or sent directly to scanning device 100. At step 1050, the data from offers made directly to the consumer are stored in the coupon database of scanning device 100.

FIG. 11, with reference to FIG. 3 shows a schematic of a coupon webpage, residing on server 370. Server 370 is connected to internet 300. A consumer 350 accesses the consumer's reserved area 1120 residing on the coupon webpage by registering and creating a login. The consumer's reserved area 1120 stores demographic, purchase and coupon information about that individual consumer. Consumer 350 accesses webpage application 1130 through consumer reserved area 1120. Webpage application 1130 is controlled by a graphical user interface (GUI). Application buttons 1140 reside on webpage application 1130. Application buttons 1140 allows user searches 1150 based on product, manufacturer, amount of discount, or expiration date of offers. The webpage application 1130 returns coupon data found in the search 1160 to server 370. Coupon data that is returned by webpage application 1130 may be stored in consumer's reserved area 1120, sent directly to consumer's personal computer 310 or sent directly to scanning device 100.

In use, coupon data is entered into scanning device 100 as described in FIGS. 1, 2, 6-8, and 1. As consumer 350 shops, scanning device 100 compares data from scanned objects with coupon data as described in FIGS. 5, 7 and 8. Coupons or offers are then redeemed as products are purchased as described in FIG. 7.

1. A system for manipulating coupon data comprising:
a PDA, including a memory, connected to a scanner;
a first coupon dataset, derived from the scanner, including data from a physical coupon, stored in the memory;
a second coupon dataset, downloaded from the internet and stored in the memory, including data from an electronic coupon;
a product dataset, derived from the scanner, related to a product and stored in the memory; and,
a software application, residing on the PDA, for comparing the first coupon dataset to the purchased product dataset to determine a first coupon match and for comparing the second coupon dataset to the purchased product dataset to determine a second coupon match.

2. The system of claim 1 wherein the scanner is one of the group of a barcode scanner and an RFID scanner.

3. The system of claim 1 further comprising:
a search website in communication with the PDA;
the search website programmed to:
upload a third coupon dataset to the PDA, and
conduct a search for a coupon that correlates to a product in the product dataset.

4. In a computer system comprised of a portable data processor including a scanning device and a display, the portable data processor connected to a manufacturer computer and a retailer computer, a method of organizing sales coupon data comprising the steps of:
scanning a coupon with the scanning device;
creating an image, relating to the coupon, on the display; and
using the retailer computer to redeem the coupon by accessing the image.

5. The method of claim 5 including the further step of:
registering a set of consumer data, related to a consumer, on the manufacturer computer.

6. The method of claim 6 including the further step of:
moving a sales incentive, related to the set of consumer data, from the manufacturer computer to the portable data processor.

7. The method of claim 5 including the further steps of:
searching the manufacturer computer for a coupon dataset that correlates to a set of products to be purchased; and,
moving the coupon dataset to the portable data processor.

8. A method of using coupons comprising the steps of:
loading a first coupon dataset, related to a paper coupon, into a scanning device;
loading a second coupon dataset, related to an electronic coupon, into the scanning device;
loading a purchased product dataset, related to product, into the scanning device;
using a software program residing on the scanning device to compare the first coupon dataset and the second coupon dataset with the purchased a product dataset to determine a match; and,
redeeming the match.

9. The method of claim 8 further comprising the steps of:
storing a set of information related to a consumer in the scanning device;
sending the set of information related to the consumer and the purchased product dataset to a server; and,
sending an electronic offer from the server to the scanning device related to the set of information related to the consumer and the purchased product dataset.

10. The method of claim 9 wherein the set of information related to a consumer is related to a redeemed coupon.

11. The method of claim 9 wherein the set of information related to a consumer is related to an unredeemed coupon.

12. The method of claim 8 comprising the further steps of::
encoding a master barcode by hashing a set of identifying data correlated to the paper coupon;
sending the master barcode to a retailer computer;
decoding the master barcode with the retailer computer to retrieve the identifying data;
redeeming the paper coupon by using the identifying data; and
notifying a manufacturer that the paper coupon has been redeemed.

13. The method of 12 including the further step of verifying that the set of identifying data is valid by contacting the manufacturer.

14. The method of 8 including the further steps of:
displaying the master barcode on a display; and
reading the master barcode from the display.

15. A coupon storage system comprising:
a portable data processor;
a display unit connected to the portable data processor;
a first memory connected to the portable data processor;
a first coupon dataset stored in the first memory;
a second coupon dataset stored in the first memory;
wherein the first coupon dataset correlates to a physical coupon; and
wherein the second coupon dataset correlates to an electronic coupon.

16. The coupon storage system of claim 15 further comprising:
a scanning unit attached to the portable data processor and wherein the first coupon dataset is derived from a signal generated by the scanning unit.

17. The coupon storage system of claim 15 further comprising:
a set of storage servers connected to the portable data processor; and
a server coupon dataset stored on the set of storage servers.

18. The coupon storage system of claim 17 further comprising:
a workstation connected to the set of storage servers and the portable data processor;
a second memory connected to the workstation;
a workstation coupon dataset stored in the second memory;
wherein the workstation coupon dataset is selected from the server coupon dataset and downloaded from the set of storage servers; and,
wherein the workstation coupon data set is communicated from the second memory to the first memory.

19. The coupon storage system of claim 17 wherein the second coupon dataset is selected from the server coupon dataset and downloaded from the set of storage servers to the first memory.

20. The coupon storage system of claim 17 further comprising a master server in data communication with the portable data processor and wherein the portable data processor is programmed to upload a master barcode to the master server.

21. The coupon storage system of claim 20 wherein the master server is programmed to decode the master barcode to derive the first coupon dataset and communicate the first coupon dataset to the set of storage servers.

22. The coupon storage system of claim 21 wherein the portable data processor is programmed to hash the first coupon data set during creation of the master barcode.

23. The coupon storage system of claim 22 wherein the portable data processor is programmed to display the master barcode on the display unit.

24. The coupon storage system of claim 17 wherein the portable data processor is programmed to search the server coupon dataset for data related to a product scanned and download a match data coupon dataset from the server coupon dataset that correlates to the product scanned, to the portable data processor.

25. The coupon storage system of claim 17 wherein the portable data processor is programmed to redeem a coupon by communication with a retailer computer system.
